(19) United States
(12) Patent Application Publication
(10) Pub. No.: US 2025/0095498 A1
(43) Pub. Date: Mar. 20, 2025

(54) METHOD AND SYSTEM FOR MONITORING A SAFETY LEVEL OF A TRAJECTORY OF AN AIRCRAFT AND FOR GENERATING A CORRESPONDING ALERT

(71) Applicant: Airbus Operations (S.A.S.), Toulouse (FR)

(72) Inventors: Thomas Pastre, Toulouse (FR); Miguel Consiglieri Pedroso Mendes Dias, Toulouse (FR); Fabien Perrin, Toulouse (FR)

(21) Appl. No.: 18/829,430

(22) Filed: Sep. 10, 2024

(30) Foreign Application Priority Data
Sep. 15, 2023 (FR) 2309741

(51) Int. Cl. G08G 5/00

(52) U.S. Cl. CPC G08G 5/21; G08G 5/34; G08G 5/55; G08G 5/58

(57) ABSTRACT

A method and system for monitoring a safety level of a trajectory followed by a flying aircraft. The system selects, from among a set of integration points, the integration point at the position farthest from the current position of the aircraft on the trajectory. The system checks whether part of the trajectory extending from the current position of the aircraft to the position of the selected integration point is safe if no conflict is detected, and a contingency trajectory exists. These steps are repeated for each integration point, one step at a time until a safe trajectory is found. This results in a safety level dependent on the integration point from which the trajectory is considered to be safe. It is possible to anticipate any conflicts and, if necessary, to seamlessly carry out operations for diverting the aircraft.

### TECHNICAL FIELD

The disclosure herein relates to a method and a system for monitoring a safety level of a trajectory of an aircraft conflicting with an obstacle. In addition, the method and the system according to the disclosure herein relate to generating alert messages whose criticality level depends on the safety level of the trajectory.

### BACKGROUND

A flying aircraft experiences various constraints influencing its navigation and more specifically affecting its flight plan. Thus, numerous obstacles must be taken into account when determining a flyable trajectory: the relief of the terrain, meteorological obstacles, military zones prohibiting overflight, the operational state of the aircraft (cabin depressurization, engine shutdown, etc.). A flyable trajectory is a trajectory that at any point has a minimum (or predetermined) distance margin relative to any identified obstacle (relief, etc.) and that the aircraft can follow given its operational state (possible depressurization, loss of an engine, etc.).

While some obstacles are foreseeable when the flight plan is established (for example, relief, restricted area, etc.), others, on the contrary, can appear during the flight (for example, critical meteorological events, other aircraft, etc.). Thus, in order to be able to avoid these obstacles that appear during the flight, it is worthwhile providing automatic assistance for automatically detecting these obstacles, notably in order to anticipate following a trajectory for avoiding them. More specifically, when obstacles are detected that are about to conflict with the initial flight plan of the aircraft, it is worthwhile being able to warn the crew so that they can prepare and seamlessly carry out tactical obstacle avoidance operations. In particular, it is worthwhile providing a solution for anticipating these obstacles and, if necessary, generating an alert message whose criticality level is adapted to the situation, notably in terms of the reaction time before the obstacle is encountered.

### SUMMARY

One aim of the disclosure herein is a method for monitoring a safety level of a trajectory followed by a flying aircraft, with the method being implemented by a system in the form of electronic circuitry on board the aircraft, the method comprising: defining a set of integration points positioned along the trajectory, downstream of a current position of the aircraft on the trajectory; the method further comprising a monitoring phase comprising at least one iteration, by initially selecting the integration point at the position farthest from a current position of the aircraft, with each iteration comprising: determining whether the position of the selected integration point is different from the position of the integration point closest to the current position of the aircraft, otherwise establishing a failure to compute a contingency trajectory; when the position of the selected integration point is different from the position of the integration point closest to the current position of the aircraft: checking whether part of the trajectory, called common part, extending from the current position of the aircraft to the position of the selected integration point is safe if: (i) no conflict between an obstacle and the common part is detected, and (ii) a contingency trajectory exists from the position of the selected integration point, otherwise carrying out a new iteration of the monitoring phase by selecting the next integration point toward the current position of the aircraft, and the method further comprising: establishing a safety level for the trajectory, with the safety level either corresponding to the position of the integration point at which the failure to compute the contingency trajectory was established, or to the position of the integration point at which the common part is safe.

Thus, depending on the number and the position of integration points along the trajectory followed by the aircraft, downstream of its current position, it is possible to define a desired number of safety levels. It is thus possible to anticipate any conflicts arising along the trajectory followed by the aircraft and, if necessary, to carry out aircraft contingency operations with a view to seamlessly avoiding these conflicts.

According to a particular embodiment, the method further comprises, following the monitoring phase, a phase of alerting a crew of the aircraft comprising: generating an alert message indicating a criticality level depending on the established safety level, with the criticality level determining at least one action to be implemented by the crew of the aircraft.

According to a particular embodiment, the method comprises the following steps: determining incapacitation of the crew of the aircraft in the event of failure, for a predefined period, to implement the at least one action or in the event of implementation of an action that is unsuitable for the criticality level of the alert message; automatically initiating a contingency trajectory if the crew is incapacitated.

According to a particular embodiment, the alert message comprises a graphical type notification, displayed on a screen of a human-machine interface in a cockpit of the aircraft.

According to a particular embodiment, the notification comprises a graphical representation of an operable button intended for deleting the notification.

According to a particular embodiment, the notification comprises a graphical representation of an operable button intended for going through the obstacle.

According to a particular embodiment, when the crew activates the button intended for going through the obstacle, then the system considers that the obstacle is no longer an obstacle and the method comprises repeating the phase of monitoring the safety level of the trajectory.

A system is also disclosed in the form of electronic circuitry on board the aircraft, with the system comprising electronic circuitry configured to implement the following: defining a set of integration points positioned along the trajectory, downstream of a current position of the aircraft on the trajectory; the electronic circuitry is further configured to implement a monitoring phase comprising at least one iteration, by initially selecting the integration point at the position farthest from a current position of the aircraft, with each iteration comprising: determining whether the position of the selected integration point is different from the position of the integration point closest to the current position of the aircraft, otherwise establishing a failure to compute a contingency trajectory, when the position of the selected integration point is different from the position of the integration point closest to the current position of the aircraft: checking whether part of the trajectory, called common part, extending from the current position of the aircraft to the position of the selected integration point is safe if: (i) no conflict between an obstacle and the common part is detected, and (ii) a contingency trajectory exists from the position of the selected integration point, otherwise carrying out a new iteration of the monitoring phase by selecting the next integration point toward the current position of the aircraft, and the electronic circuitry is further configured for implementing the following: establishing a safety level for the trajectory, with the safety level either corresponding to the position of the integration point at which the failure to compute the contingency trajectory was established, or to the position of the integration point at which the common part is safe.

A computer program product is also proposed, comprising instructions causing a processor to execute the aforementioned method according to any one of its embodiments, when the instructions are executed by the processor. A storage medium storing such instructions is also proposed.

### BRIEF DESCRIPTION OF THE DRAWINGS

The aforementioned features of the disclosure herein, as well as other features, will become more clearly apparent upon reading the following description of at least one example embodiment, with the description being provided with reference to the attached drawings, in which:

FIG. 1 schematically illustrates a side view of an aircraft equipped with a system for monitoring a safety level of a trajectory and for generating alert messages;

FIG. 2 schematically illustrates the system for monitoring a safety level of a trajectory and for generating alert messages, in an embodiment;

FIG. 3 schematically illustrates an example of the hardware architecture of the system for monitoring a safety level of a trajectory and for generating alert messages;

FIG. 4 schematically illustrates an example of a trajectory followed by the aircraft for which a set of integration points is defined;

FIG. 5 schematically illustrates an example of an algorithm for monitoring a safety level of a trajectory of the aircraft and for generating corresponding alert messages;

FIG. 6 schematically illustrates an example of graphical representations of alert messages depending on the safety level of the trajectory of the aircraft; and

FIG. 7 schematically illustrates an example of graphical representations of alert messages in the event of suspected incapacitation of crew of the aircraft.

### DETAILED DESCRIPTION

The present disclosure proposes determining a safety level for a trajectory followed by a flying aircraft when a conflict with an obstacle is detected and generating alert messages adapted to each situation. More specifically, the present disclosure proposes a method for assessing the safety of a trajectory by defining a desired number of alert levels, each associated with an anticipation time for the detected conflict, and notifying an aircraft crew thereof accordingly.

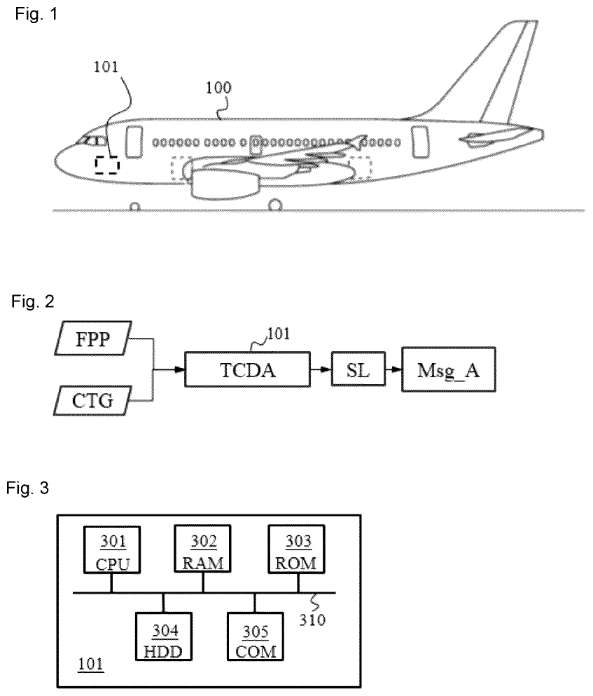

FIG. 1 schematically illustrates a side view of an aircraft 100 equipped with a system for monitoring a safety level of a trajectory and for generating alert messages. For the sake of simplicity, this system for monitoring a safety level of a trajectory and for generating alert messages will be referred to hereafter as TCDA (Trajectory Conflict Detection and Alerting) system 101.

The TCDA system 101 is on-board electronic equipment. For example, the TCDA system 101 forms part of the electronic circuitry of the avionics of the aircraft 100. Preferably, the TCDA system 101 is integrated into a computer of the aircraft 100, for example, the Flight Management System (FMS) of the aircraft 100 or another trajectory computation system distinct from the FMS.

The TCDA system 101 is a pilot assistance system for determining, in real time, whether a trajectory followed by the aircraft 100 is safe and flyable.

More specifically, the TCDA system 101 determines, during a monitoring phase, whether the trajectory that the aircraft 100 is supposed to follow in the next n minutes is safe. More specifically, the TCDA system 101 determines
that the trajectory is safe if the following conditions are met, namely: there are no obstacles (for example, terrain, critical meteorological conditions, restricted areas or other obstacles to be avoided) conflicting with this trajectory; and
based on the expected operational state of the aircraft 100 (for example, cabin depressurization, engine shutdown, etc.), a contingency trajectory exists.

If the trajectory followed by the aircraft is only safe up to a certain point on the trajectory, the TCDA system 101 then establishes a safety level for the trajectory.

During a crew alert phase, the TCDA system then generates alert messages adapted to the previously determined safety level. These messages are then transmitted to a human-machine interface in the cockpit of the aircraft 100, either directly for the attention of the crew or for the attention of an on-board flight assistant application, allowing the latter to suggest tactical conflict avoidance to the crew.

The TCDA system 101 is schematically illustrated in FIG. 2, in an embodiment. The TCDA system 101 is configured to take a set of information provided by various avionics systems as input, notably a Flight Path Predictor (FPP) and a Contingency Trajectory Generator (CTG) system.

The flight path predictor system FPP predicts, in real time, the 4D trajectory that the aircraft 100 will follow in the next few minutes, by integrating several integration points where the aircraft 100 will be located at specific times along the flight path. To this end, it takes into account a set of information provided by the avionics, notably the current geographical position of the aircraft 100, the current velocity or speed of the aircraft 100, the current direction of flight of the aircraft 100 as defined by the attitude of the aircraft 100, etc.

Based on a given operational state of the aircraft 100, the contingency trajectory generator system CTG is capable of computing, in real time, a contingency trajectory in the event of an obstacle (for example, terrain, critical meteorological conditions, restricted areas or other obstacles to be avoided) and which is flyable (in terms of the operational state and the performance capabilities of the aircraft 100). Such a system is notably described in patent application EP 4083966 of the Applicant.

More specifically, such a contingency trajectory generator system CTG takes into account a set of information provided by the avionics, as well as information provided by a set of databases. These databases notably provide terrain elevation information in the form of polygons as ranges of altitude, geo-referenced information, preferably as ranges of altitude, in the form of polygons of military zones prohibiting overflight, geo-referenced information in the form of polygons, preferably as ranges of altitude, of zones to be avoided due to meteorological conditions (storm clouds, etc.), and information concerning the performance capabilities of the aircraft 100 according to its operational status. These databases can be fully integrated into a computer system of the aircraft 100. Before take-off, the databases are updated, for example, using an Electronic Flight Bag (EFB). The databases can be integrated into a ground-based computer system, for example, a computer center of an airline under which the aircraft 100 operates. The databases on board the aircraft 100 are then updated using Air Ground Communications (AGC). These two approaches can be combined, with the databases being pre-loaded before take-off and with in-flight updates, for example, in order to take into account data changes in real time (weather conditions, etc.).

Thus, by virtue of all the information provided by the flight path predictor FPP and contingency trajectory generation CTG systems, the TCDA system 101 is able to output information concerning a safety level (denoted SL) of the trajectory followed by the aircraft 100, triggering, if necessary, the generation, then the transmission to a human-machine interface, of an alert message (denoted Msg_A) whose criticality level depends on the determined safety level.

FIG. 3 schematically illustrates an example of the hardware architecture of the TCDA system 101, which then comprises, linked by a communication bus 310: a processor or CPU (Central Processing Unit) 301; a RAM (Random Access Memory) 302; a ROM (Read Only Memory) 303, for example, a Flash memory; a data storage device, such as a Hard Disk Drive (HDD), or a storage media reader, such as a Secure Digital (SD) card reader 304; at least one communication interface 305 allowing the TCDA system 101 to interact in the avionics of the aircraft 100.

The processor 301 is capable of executing instructions loaded into the RAM 302 from the ROM 303, an external memory (not shown), a storage medium, such as an SD card, or a communications network (not shown). When the TCDA system 101 is powered up, the processor 301 is capable of reading instructions from the RAM 302 and of executing them. These instructions form a computer program causing the processor 301 to implement the behaviors, steps and algorithms described herein.

All or some of the behaviors, steps and algorithms described herein can thus be implemented in software form by executing a set of instructions using a programmable machine, such as a DSP (Digital Signal Processor) or a microcontroller, or can be implemented in hardware form using a dedicated machine or component (a chip) or a set of components (a chipset), such as a Field-Programmable Gate Array (FPGA) or an Application-Specific Integrated Circuit (ASIC). In general, the TCDA system 101 comprises electronic circuitry arranged and configured to implement the behaviors, steps and algorithms described herein.

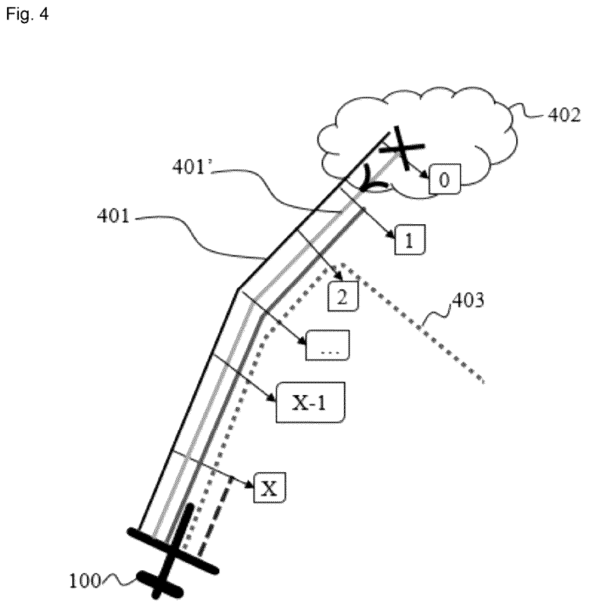

FIG. 4 schematically illustrates an example of a trajectory 401 followed by the aircraft 100 for which a set of integration points is defined.

“Common part” is understood to mean part of the trajectory 401 followed by the aircraft 100 that extends from the current position of the aircraft 100 to an integration point positioned downstream of the current position of the aircraft 100 on the trajectory 401. Thus, several integration points define several different respective common parts.

The trajectory 401 can comprise one or more integration points downstream of the current position of the aircraft 100. The number and the position over time of the integration points on the trajectory 401 depend on a desired anticipation time for the trajectory. In other words, the integration points are placed downstream of the current position of the aircraft 100 on the trajectory 401, at predetermined flight times, or at predetermined distances. For example, the spacing of the integration points notably depends on the flight speed of the aircraft 100. Indeed, the higher the speed of the aircraft 100, the greater the number of integration points (i.e., integration points that are close together timewise along the trajectory 401) in order to anticipate and to quickly react to events occurring on the trajectory 401 being followed. Conversely, the lower the speed of the aircraft 100, the fewer integration points there are to position, since there is more time to anticipate and to react to potential events on the trajectory 401.

In this example, an obstacle (such as a critical meteorological event) 402 conflicts with the trajectory 401 followed by the aircraft 100.

The flight path predictor system FPP and the contingency trajectory generator system CTG described above take into account the number and the position over time of the integration points.

The number of integration points included on the trajectory 401 thus defines the safety levels of the trajectory 401 according to the algorithm for monitoring the safety level and for generating alert messages which is described hereafter. Depending on these safety levels, various alert messages can be generated by the TCDA system 101. These alert messages are then transmitted by the TCDA system 101 to a human-machine interface in the cockpit of the aircraft 100 and/or to a ground-based control center for controlling the aircraft 100.

These alert messages can be in the form of graphical notifications displayed on a screen of a human-machine interface. Alternatively or additionally, these notifications can be audible and can be emitted by an audio system in the cockpit of the aircraft 100.

In the example associated with FIG. 4, the integration point 0 is considered to be the integration point farthest from the current position of the aircraft 100 on the trajectory 401. Thus, a common part 401′ that proceeds from the current position of the aircraft 100 to the integration point 0 can be defined. In this example, the integration point 0 is located at the point of conflict between the trajectory 401 and an obstacle 402. X denotes the integration point located closest to the current position of the aircraft 100.

The TCDA system 101 then scans the integration points along the trajectory 401 as a function of the anticipation time and of the flight speed of the aircraft 100, until it finds a safe common part. More specifically, the TCDA system 101 scans the integration points from the integration point farthest from the current position of the aircraft 100 (in this case the integration point with an index equal to 0) to the current position of the aircraft 100 (in this case the integration point with an index equal to X) until a safe common part is found.

If necessary, the aircraft 100 can follow a contingency trajectory 403. In an embodiment, the aircraft 100 follows the contingency trajectory 403. This contingency trajectory 403 is generated, for example, by the contingency trajectory generator system CTG. This contingency trajectory 403 forms a backstop to be followed in the event that emergency operations need to be performed. These emergency operations notably can be initiated automatically, potentially leading to an automatic landing (“auto-landing”).

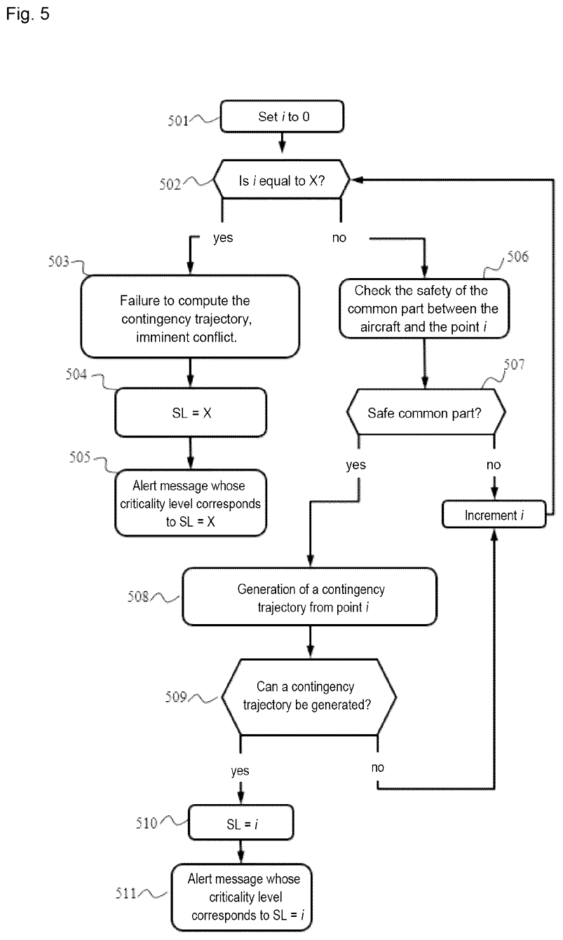

An example of the algorithm for monitoring a safety level of a trajectory of the aircraft 100 and for generating corresponding alert messages, according to an embodiment of the disclosure herein, will now be presented with reference to FIG. 5 in the form of a diagram.

This algorithm comprises two main phases: a monitoring phase and an alert phase. The monitoring phase comprises steps 501 to 504 and 506 to 510. The alert phase comprises steps 505 and 511.

In this example, x integration points are considered, with 0 being the index of the integration point farthest from the current position of the aircraft 100 and X (therefore x=X+1) being the index of the integration point located closest to the current position of the aircraft 100.

During the monitoring phase, during a step 501, the TCDA system 101 sets a variable i (with i being an integer greater than or equal to 0) to 0. This variable i is a course index for the integration points, i.e., each integration point corresponds to a value of i.

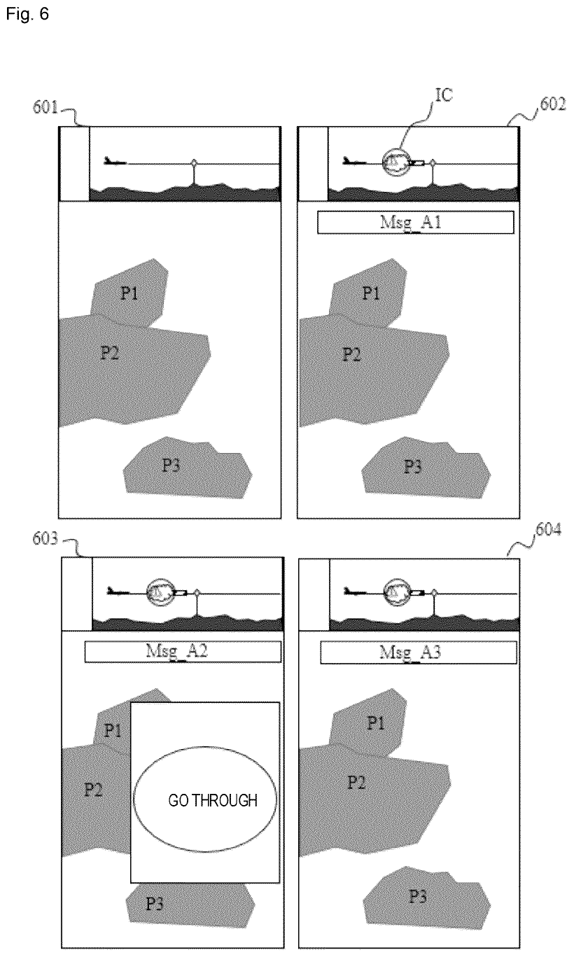

During a step 502, if i is equal to X (yes), then the TCDA system 101 determines, during a step 503, that the computation of a contingency trajectory has failed and that a conflict is imminent. In this case, in a step 504, the TCDA system 101 determines that the safety level, denoted SL, of the trajectory is equal to X. The TCDA system 101 then ends the monitoring phase in order to initiate the phase of alerting the crew. During this alert phase, in a step 505, the TCDA system 101 generates an alert message whose criticality level corresponds to the safety level SL=X. The TCDA system 101 then transmits this alert message to a human-machine interface for the attention of the crew. Such an alert message is illustrated, for example, in FIG. 6 (the case denoted 604).

Otherwise, if i is different from X during step 502 (no), the TCDA system 101 proceeds to step 506 of the monitoring phase.

During step 506, the TCDA system 101 checks the safety of the common part proceeding from the aircraft 100 to the position of the integration point with an index i:
in a step 507, if the common part is safe (yes), i.e., no conflict with an obstacle, the TCDA system 101 proceeds to step 508;
if, during step 507, the common part is not safe (no), i.e., a conflict is detected between the trajectory 401 and an obstacle, the TCDA system 101 increments i and returns to step 502.

More specifically, the variable i is incremented so as to assume a value of a next integration point, closer to the current position of the aircraft 100 on the trajectory 401.

During step 508, the TCDA system 101 determines whether there is a contingency trajectory based on the integration point with an index equal to i:
during a step 509, if there is no contingency trajectory n (no), the TCDA system 101 increments i and returns to step 502;
during step 509, if a contingency trajectory could be generated (yes), then during step 510, the TCDA system 101 determines that the safety level SL of the trajectory is equal to i.

The TCDA system 101 therefore ends the monitoring phase in order to continue with the alert phase. During this alert phase, during step 511, an alert message whose criticality level depends on the safety level SL determined during the monitoring phase is generated. Such alert messages are illustrated, for example, in FIG. 6 (the cases denoted 601 to 603).

It should be noted that the criticality level of the alert message increases with the safety level. Indeed, the more the safety level increases, the shorter the distance between the integration point selected during the monitoring phase and the current position of the aircraft 100. Thus, the time required to initiate emergency operations in order to avoid a conflict, such as, for example, changing trajectory and following the contingency trajectory 403, is shorter.

The example associated with FIG. 4 will now be used to illustrate the implementation of the algorithm described above. If i=0 (integration point with an index equal to 0) then i differs from X. The TCDA system 101 therefore checks the safety of the common part proceeding from the current position of the aircraft 100 to the integration point with an index equal to 0. An obstacle is detected, so the common part is therefore not safe.

The TCDA system 101 then increments i, and i=1, index of the integration point following the integration point with an index equal to 0. When i=1, then i differs from X, therefore, the TCDA system 101 again checks the safety of the common part proceeding from the current position of the aircraft 100 to the integration point with an index equal to 1. In this case, the common part is safe, therefore, the TCDA system 101 proceeds to the next step and attempts to generate a contingency trajectory from the integration point with an index equal to 1. In the event that i=1, no contingency trajectory can be generated. The TCDA system 101 therefore increments i, and i=2, which is the next integration point along the trajectory toward the current position of the aircraft 100.

When i=2, as i differs from X, the TCDA system 101 checks the safety of the common part proceeding from the current position of the aircraft 100 to the integration point with an index equal to 2. In this case, the common part is safe and no conflict has been detected. The TCDA system 101 then attempts to generate a contingency trajectory from this integration point. In this case, it is possible to generate a contingency trajectory from the integration point with an index equal to 2. The complete contingency trajectory is then made up of the concatenation of the common part proceeding from the current position of the aircraft 100 to the integration point with an index equal to 2 and the contingency trajectory 403.

Thus, from the output of the algorithm, the TCDA system 101 determines that the safety level of the common part is SL=2. The TCDA system 101 therefore ends the monitoring phase in order to continue with the alert phase. During the alert phase during step 511, the TCDA system 101 generates an alert message whose criticality level is equal to the safety level SL=2. Such an alert message is illustrated, for example, in FIG. 6 (the case denoted 603).

An example of graphical representations of alert messages dependent on the safety level of the trajectory 401 of the aircraft 100 will now be described with reference to FIG. 6.

In this example, the trajectory 401 followed by the aircraft 100 comprises 3 integration points. The index equal to 0 represents the integration point farthest from the current position of the aircraft 100 and the index equal to 3 represents the integration point closest (in flight time, for example) to the current position of the aircraft 100.

As previously described, the criticality level of the alert messages depends on the safety level of the trajectory 401. The higher the safety level, the closer the integration point from which the trajectory is considered to be safe is to the current position of the aircraft 100, and consequently the more critical or urgent the alert message. Depending on the criticality level of the alert message, various responses, or actions, can be implemented by the crew.

In this example, the alert messages are in the form of graphical notifications displayed on a screen of a human-machine interface in the cockpit of the aircraft 100. Other information can be displayed in conjunction with the alert message, such as the spatial position of the aircraft 100, the trajectory of the aircraft 100, a graphical representation of the obstacles in the form of polygons (denoted P1, P2 and P3), icons of the various detected obstacles (denoted IC), etc.

Thus, according to the algorithm described above with reference to FIG. 5: when the safety level output from the algorithm is SL=0 (the case denoted 601), then no alert message is generated by the TCDA system 101. This case corresponds to the fact that up to the integration point with an index equal to 0, the common part is safe (i.e., no conflict is detected) and a contingency trajectory can be generated from this integration point with an index equal to 0. The TCDA system 101 therefore does not generate an alert message for the attention of the crew, meaning that they do not have to take any particular action. In this case, no graphical notification is displayed on the screen of the human-machine interface in the cockpit of the aircraft 100.

When the safety level output from the algorithm is SL=1 (the case denoted 602), then a conflict has been detected downstream of the integration point with an index equal to 1 along the trajectory 401. In other words, the common part extending from the current position of the aircraft 100 to the integration point with an index equal to 0 is not safe. Furthermore, when SL=1, then the common part extending from the current position of the aircraft 100 to the integration point with an index equal to 1 is safe and a contingency trajectory exists from this integration point. If SL=1, an alert message whose criticality level corresponds to the safety level SL=1 is generated by the TCDA system 101. This alert message is displayed, for example, on the screen of the human-machine interface in the cockpit of the aircraft 100 in the form of a notification (denoted Msg_A1). For example, this notification Msg_A1 can be white on a black background and can indicate that there will soon be a conflict with an obstacle (for example, a critical meteorological event) if no corrective action is taken. The crew is then prompted to respond to this message by carrying out an action, such as following a contingency trajectory.

In an embodiment, some of the notifications can be cleared by the crew. Indeed, some safety levels can produce notifications that can be cleared, while others may only produce notifications that cannot be cleared until the conflict has been resolved. If a notification can be deleted by the crew, an indication such as “Delete” or “Clear” will then appear on the notification. When a notification that can be deleted is deleted by the crew, a new notification only appears if the safety level SL changes.

For example, in the case of an alert message whose criticality level corresponds to a low safety level, the notification can be cleared since the detected conflict is far from the current position of the aircraft 100. Thus, as the crew has sufficient time to avoid the obstacle, they can decide to wait for a change in the safety level to be established by the TCDA system 101 before initiating the avoidance operations. Indeed, in this case, a new notification can be issued if the safety level increases and the conflict resolution time is shorter.

In another example, in the case of an alert message whose criticality level corresponds to a high safety level, the notification cannot be cleared since the detected conflict is close to the current position of the aircraft 100. The crew does not have enough time to wait for the conflict to be resolved, and, on the contrary, this conflict must be resolved quickly.

The possibility of deleting the notification can also take into account the nature of the obstacle. Indeed, if the detected obstacle is a non-critical meteorological event, the notification displayed on the screen of the human-machine interface can be deleted since the crew can decide, for example, to go through this obstacle. On the contrary, if the obstacle is another aircraft, for example, the notification cannot be deleted since the crew absolutely must resolve the imminent conflict.

When the safety level output from the algorithm is SL=2 (the case denoted 603), then this means that the common part proceeding from the current position of the aircraft 100 to the integration point with an index equal to 2 is safe and that a contingency trajectory exists. However, it also means that the time for resolving the conflict detected downstream of the position of the integration point with an index equal to 2 (for example, at the integration point with an index equal to 1 or 0) is shorter. This also means that no other contingency trajectory could be generated downstream of the integration point with an index equal to 2. In other words, the integration point with an index equal to 2 is the last point from which the crew can initiate conflict avoidance operations.

In this case, an alert message whose criticality level corresponds to safety level SL=2 is generated by the TCDA system 101. This alert message is then transmitted to the human-machine interface in the cockpit of the aircraft 100 and is displayed on a screen of the human-machine interface in the form of a graphical notification (denoted Msg_A2). In one example, this notification is orange and indicates that the conflict is very close and that it must be urgently resolved. In response, the crew must activate the contingency trajectory.

In an alternative embodiment, this notification Msg_A2 also includes a graphical representation of an operable button, called “Go-Through” button. This “Go-Through” button allows the crew to express their intention to go through the conflicting obstacle by pressing it, for example. More specifically, the TCDA system 101 is capable of detecting when the crew has activated this button (by pressing it, for example). The TCDA system 101 then considers the detected obstacle to no longer be an obstacle and repeats the monitoring phase. This action of “going through” the conflict is available for a predefined period and can depend on the nature of the detected obstacle. Indeed, while it is possible to “go through” a meteorological event, it is not possible to “go through” another aircraft or a restricted area, for example. Beyond the predefined period, if the crew has not initiated emergency operations, the TCDA system 101 considers that the crew has not responded to the alert message. In an embodiment described hereafter, the lack of action from the crew results in a presumption of incapacitation.

When the safety level output from the algorithm is SL=3 (the case denoted 604), then either the common parts downstream of the integration point with an index equal to 3 are not safe, or they are safe but no contingency trajectory exists. The conflict is then imminent. The TCDA system 101 therefore generates a message whose criticality level corresponds to safety level SL=3. This alert message is then displayed on a screen of a human-machine interface in the cockpit of the aircraft 100 in the form of a graphical notification (denoted Msg_A3). This notification Msg_A3 is red, for example, and notifies the crew that a conflict is imminent and that a contingency trajectory must be urgently activated.

It should be noted that in the embodiment where the alert message is in the form of an audible notification, depending on the safety level, the frequency and/or the volume of the audible notification can change. In one example, when the safety level SL is low, then the alert message can be a sound at a low frequency (for example, a frequency between 20 Hz and 200 Hz) and/or that is emitted at a low volume (for example, between 20 and 40 dB). In another example, when the safety level is high, the audible notification can be a high frequency sound (for example, a frequency between 2,001 Hz and 20,000 Hz) and/or that is emitted at a high volume (for example, between 60 and 80 dB).

In an embodiment, in the event of a failure to compute a contingency trajectory, then the TCDA system 101 can retrieve a contingency trajectory from its memory that was computed during a previous monitoring phase and can activate the trajectory.

Therefore, a margin or distance (expressed as flight time, for example) exists between the current position of the aircraft 100 and the closest integration point, denoted X, that is sufficient to be able to immediately activate (for example, in the event that the crew is deemed to be incapacitated), i.e., before the aircraft 100 reaches the integration point X closest to its current position, a contingency trajectory computed for this integration point X during a previous monitoring phase. In other words, activating the contingency trajectory stored to memory is only possible if the distance (expressed as flight time, for example) between the current position of the aircraft 100 and the integration point, denoted X, closest to the aircraft 100 is sufficient to compensate for the time that has elapsed since the contingency trajectory computation failed.

This contingency trajectory stored to memory can be activated as a backstop in order to re-establish a safe situation for the aircraft 100.

In another embodiment, when a “Go-Through” button has appeared on the screen of the human-machine interface in the cockpit of the aircraft 100 before the conflict, following a failure to compute the contingency trajectory, the contingency trajectory stored to memory is only activated if the crew has not expressed their intention to go through the conflicting obstacle. Otherwise, the contingency trajectory stored to memory is not followed.

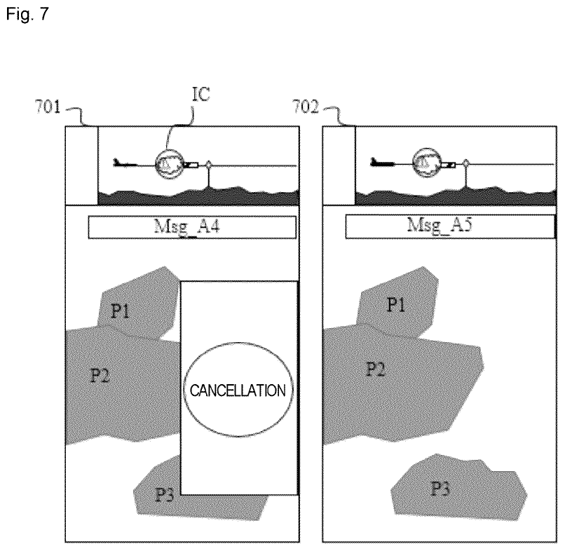

FIG. 7 illustrates an example of graphical representations of alert messages if crew incapacitation is suspected or presumed.

This suspicion of incapacitation (the case denoted 701) of the crew is raised when:
no action is taken by the crew;
the crew takes action that is unsuitable for the situation;
the crew has not expressed their intention to go through the conflicting obstacle (for example, by pressing the “Go-Through” button);
in response to an alert message generated following a failure to compute the contingency trajectory (according to the algorithm described with reference to FIG. 5, where i=X) and when a contingency trajectory must be urgently activated because a conflict is imminent.

An alert message is then generated by the TCDA system 101, for example, in the form of a notification (denoted Msg_A4). This graphical notification Msg_A4 is red, for example, and notifies the crew that a contingency trajectory has been followed, for example, via automated emergency operations.

In an alternative embodiment, this notification Msg_A4 can be accompanied by additional information notifying the crew of a presumption of incapacitation and that automated emergency operations have been implemented.

As an alternative embodiment, this additional notification Msg_A4 also includes an operable “Cancel” button that is available for a certain period (for example, 30 seconds), which provides the crew with the option of cancelling these automated emergency operations. In this case, the TCDA system 101 detects the action of the crew and cancels the automated emergency operations. The TCDA system 101 then resumes monitoring any action by the crew. The crew has the option of carrying out the emergency operations themselves in response to the alert message, or of expressing their intention to “go through” the obstacle, if such an action is possible (for example, by pressing a “Go-Through” button).

If the crew is unable to act (the case denoted 702), and, furthermore, they do not cancel the automated emergency operations, then these automated emergency operations are activated by the TCDA system 101. An automatic announcement of the intention of the aircraft 100 is then transmitted over the radio in the cockpit of the aircraft 100.

In addition, an alert message notifying the crew of the activation of automated emergency operations is generated by the TCDA system 101 and is displayed on a screen of a human-machine interface in the cockpit of the aircraft 100, for example, in the form of a graphical notification (denoted Msg_A5).

Otherwise, the crew uses the radio to explain what is happening and can resume control of the aircraft 100 if they wish. A new monitoring phase is then implemented by the TCDA system 101, followed, if necessary, by a new alert phase.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for monitoring a safety level of a trajectory followed by a flying aircraft, implemented by a Trajectory Conflict Detection and Alerting (TCDA) system comprising electronic circuitry on board the aircraft, the method comprising:
defining a set of integration points positioned along a trajectory, downstream of a current position of the aircraft on the trajectory;
a monitoring phase comprising at least one iteration, by initially selecting an integration point at a position farthest from a current position of the aircraft, with each iteration comprising:
determining whether the position of the selected integration point is different from a position of the integration point closest to the current position of the aircraft, otherwise establishing a failure to compute a contingency trajectory;
when the position of the selected integration point is different from the position of the integration point closest to the current position of the aircraft:
checking whether part of the trajectory, called common part, extending from the current position of the aircraft to the position of the selected integration point is safe if: (i) no conflict between an obstacle and the common part is detected, and (ii) a contingency trajectory exists from the position of the selected integration point,
otherwise carrying out a new iteration of the monitoring phase by selecting a next integration point toward the current position of the aircraft,
and the method further comprising:
establishing a safety level for the trajectory, with the safety level either corresponding to the position of the integration point at which failure to compute the contingency trajectory was established, or to the position of the integration point at which the common part is safe.

2. The method of claim 1, further comprising, following the monitoring phase, a phase of alerting a crew of the aircraft comprising generating an alert message indicating a criticality level depending on the safety level, with the criticality level determining at least one action to be implemented by the crew of the aircraft.

3. The method of claim 2, comprising:
determining incapacitation of the crew of the aircraft in an event of failure, for a predefined period, to implement the at least one action or in an event of implementation of an action that is unsuitable for the criticality level of the alert message; and
automatically initiating a contingency trajectory if the crew is incapacitated.

4. The method of claim 2, wherein the alert message comprises a graphical notification, displayed on a screen of a human-machine interface in a cockpit of the aircraft.

5. The method of claim 4, wherein the notification comprises a graphical representation of an operable button for deleting the notification.

6. The method of claim 4, wherein the notification comprises a graphical representation of an operable button for going through the obstacle.

7. The method of claim 6, wherein when the button for going through the obstacle is activated, then the TCDA system considers that the obstacle is no longer an obstacle and the method comprises repeating the monitoring phase for monitoring the safety level of the trajectory.

8. A Trajectory Conflict Detection and Alerting (TCDA) system comprising electronic circuitry on board an aircraft configured to:
define a set of integration points positioned along the trajectory, downstream of a current position of the aircraft on a trajectory;
implement a monitoring phase comprising at least one iteration, by initially selecting an integration point at a position farthest from a current position of the aircraft, with each iteration comprising:
determining whether the position of the selected integration point is different from a position of the integration point closest to the current position of the aircraft, otherwise establishing a failure to compute a contingency trajectory;
when the position of the selected integration point is different from the position of the integration point closest to the current position of the aircraft:
checking whether part of the trajectory, called common part, extending from the current position of the aircraft to the position of the selected integration point is safe if: (i) no conflict between an obstacle and the common part is detected, and (ii) a contingency trajectory exists from the position of the selected integration point,
otherwise carrying out a new iteration of the monitoring phase by selecting a next integration point toward the current position of the aircraft,
and the system further configured for establishing a safety level for the trajectory, with the safety level either corresponding to the position of the integration point at which failure to compute the contingency trajectory was established, or to the position of the integration point at which the common part is safe.

9. A computer program product, comprising instructions causing a processor to execute the method of claim 1 when the instructions are executed by the processor.

10. A storage medium, storing a computer program comprising instructions causing a processor to execute the method of claim 1 when the instructions are read and executed by the processor.
